(19) United States
(12) Patent Application Publication
(10) Pub. No.: US 2018/0068003 A1
(43) Pub. Date: Mar. 8, 2018

(54) UPDATING A LOCAL INSTANCE OF A SHARED DRIVE

(71) Applicant: Hewlett-Packard Development Company, L.P., Houston, TX (US)

(72) Inventors: Gary Lewis Poole, Fort Collins, CO (US); Baljit Singh, Fort Collins, CO (US); Robert P Cazier, Fort Collins, CO (US)

(21) Appl. No.: 15/557,754

(22) PCT Filed: Jul. 31, 2015
(86) PCT No.: PCT/US2015/043180

§ 371 Date: Sep. 12, 2017

(51) Int. Cl. G06F 17/30; G06F 15/16

(52) U.S. Cl. CPC G06F 17/30575; G06F 17/302; G06F 17/30144; G06F 15/16

(57) ABSTRACT

A schema for a shared drive can be updated so as to be current at multiple instances over a given duration. A schema of a given device that implements an outdated instance of the shared drive is matched to the schema of a prior version of the shared drive on order to map local items for use with the shared drive.

### BACKGROUND

There are numerous computing environments in which end terminals are linked to provide a shared data space that can be used on each device. The organizational structure of the shared data space, sometimes referred to as a shared drive, can be maintained by a schema, which can be stored off-device and/or locally on each device.

### BRIEF DESCRIPTION OF THE DRAWINGS

FIG. 1 illustrates an example of a shared drive system.

FIG. 2 illustrates an example system in which a backup device can be provided a local instance of a shared drive.

FIG. 3 illustrates an example method for updating instance of a shared drive that is out of date.

FIG 4 illustrates an example method for updating an instance of a shared drive which is to be used in order to back up or establish a new device for use with a shared drive.

FIG. 5 is a block diagram that illustrates an example computer system upon which embodiments described herein may be implemented.

### DETAILED DESCRIPTION

Examples provide for updating an outdated instance of a shared drive on a given device so that a schema for an instance of the shared drive is current. In particular, the schema of the instance can be made current in a manner which provides for folders, files and other items which are local on the device to be mapped into a structure and organization that is consistent with the current view of the shared drive, as provided by the current schema for the drive.

In examples as described, items of the shared drive are distributed amongst multiple devices that collectively contribute and form the shared drive. When a device utilizes an outdated instance of the shared drive, the schema of the outdated version can be matched to a recorded schema of a prior version of the shared drive. The modifications which are made to the prior version of the shared drive can then be determined and implemented on the outdated version of the shared drive, resulting in the outdated shared drive being updated to having a schema that matches or conforms to that of the current drive.

According to some examples, a schema for a shared drive can be updated so as to be current at multiple instances over a given duration. As provided with various examples, the schema can include (i) a collection of items, such as devices, folders, files and other network resources, and (ii) an organization for the collection of items which specifies a location of individual items relative to other items in the collection. The collection of items can include multiple sets of items of different kinds, including items representing each of (i) multiple devices that are operable to contribute files to the shared drive, and (ii) multiple folders that are provided for the shared drive. A schema of a given description that implements an outdated instance of the shared drive is matched to the schema of a prior version of the shared drive. Additionally, a set of mapping operations are determined to update the instance of the shared drive on the given device so that the schema of the instance of the shared drive matches the schema of the shared drive that is current.

In some variations, the information about individual items which change the schema of the shared drive over a given duration are recorded. When the schema is changed, the signature of the current schema is recorded. In this way, signatures of the schema in the prior states are recorded, as well as the event (e.g., operation(s)) which result in the schema changing. The set of operations can be determined from events which are recorded as changing the schema from when the matching schema of the prior state was determined.

In another variation, a schema is determined for the shared drive at multiple instances over a given duration. A signature of the schema is determined after each of multiple instances in a given duration when the schema is updated, so that the signature of the schema is determined for multiple prior states of the schema. When a backup resource on which at least a portion of the shared drive has been archived is to be used, a signature of the schema on the given resource is matched to the signature of the schema in one of the multiple prior states. A set of mapping operations are determined for items of the schema in the matched prior state and items of the schema that is current. The set of mapping operations are implemented when at least the portion of the shared drive are restored from the backup resource onto another device that is to use the shared device.

The term “schema” refers to the organizational structure of a defined data space. In examples provided, the defined data space (alternatively referred to a “shared drive”) can include files and/or folders that are physically distributed onto multiple devices, but logically structured and represented as being part of the shared drive. Likewise, the shared drive can be accessible on one or more devices. For example, in one implementation, the shared drive logically structures and represents files that are physically located on multiple devices of a user, household, or entity, and further enables each of the multiple devices to access the shared drive and retrieve any of the files, including those which physically reside on other devices, as if the files were locally stored.

As described with many examples, the schema of a shared drive can change over time. Examples as described provide that changes can be made to a schema of a shared drive, by way of (i) addition of new devices, folders or other network entities that are to be part of the drive, (ii) removal of devices, folders, or network entities folders that were existing in the drive, and (iii) a change in the organization of the devices or folders that are represented in the virtual drive. For simplicity, the schema is said to include “items” where each “item” is a presentation of a device, folder, file, or other network entity (e.g., online account) which can hold files or information.

In examples as described, the visual representation of the various devices, folders, files and network entities of the drive can be generated from the schema, with each item of the schema being rendered as a display object. Changes to the schema can be reflected with addition/deletion of items, altering the organization of the some items relative to others, and/or changing the name of individual items.

As the schema changes over time, the current schema may be said to have prior versions. Thus, the schema of a given drive can be different at two different instances of time in terms of the number and selection of items, identifiers of item and/or organization of items, and these differences are said to represent different versions of the schema at different times.

Among other benefits and technical affects, examples as described improve various facets relating to network computing technology, including the efficiency (e.g., such as measured by time or computing resources) by which a shared network drive can be backed up, restored or established on a new device. In particular, some examples significantly improve the efficiency of connected computing devices which operate to restore or establish a shared drive on a given device.

In other variations, examples are implemented using instructions that are stored with a non-transitory computer readable medium that is executable by one or more processors, to cause the one or more processors to perform an example method as described.

Examples described herein provide that methods, techniques, and actions performed by a computing device are performed programmatically, or as a computer-implemented method. Examples may be implemented as hardware, or a combination of hardware (e.g., a processors)) and executable instructions (e.g., stored on a machine-readable storage medium). These instructions can be stored in one or more memory resources of the computing device. A programmatically performed step may or may not be automatic.

Examples described herein can be implemented using modules or components, which may be any combination of hardware and programming to implement the functionalities of the modules or components. In examples described herein, such combinations of hardware and programming may be implemented in a number of different ways. For example, the programming for the components may be processor executable instructions stored on at least one non-transitory machine-readable storage medium and the hardware for the components may include at least one processing resource to execute those instructions. In such examples, the at least one machine-readable storage medium may store instructions that, when executed by the at least one processing resource, implement the modules or components. In examples, a system may include the machine-readable storage medium storing the instructions and the processing resource to execute the instructions, or the machine-readable storage medium may be separate but accessible to the system and the processing resource.

Furthermore, examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be earned and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

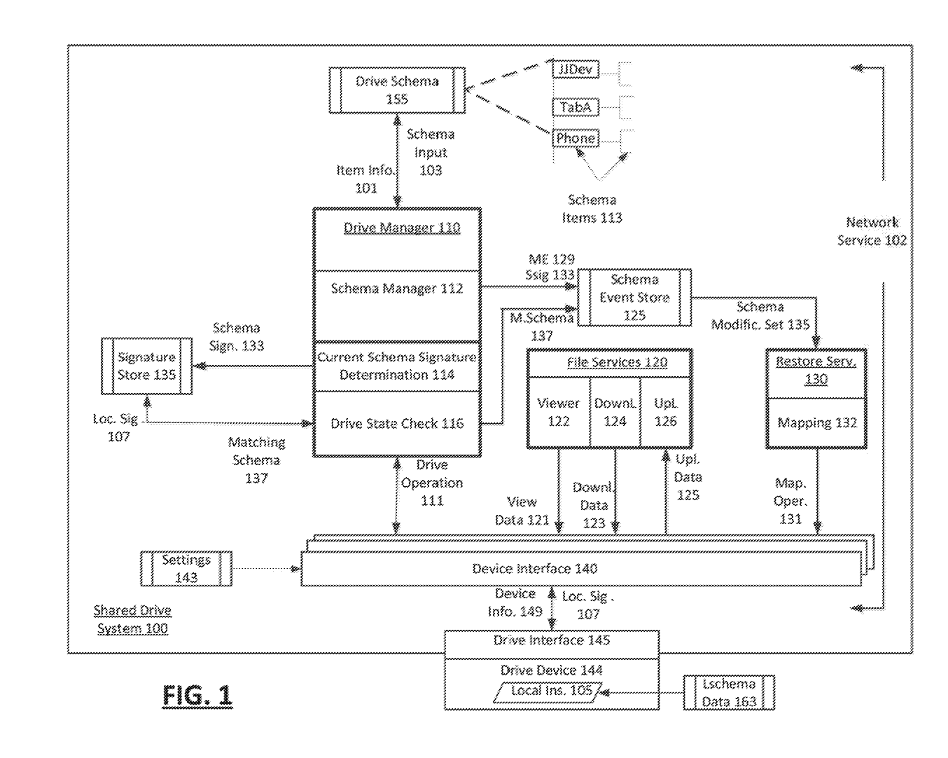

FIG. 1 illustrates an example of a shared drive system. A shared drive system as shown, and described with FIG. 1 can include a network side service 102 or sub-system and one or more drive interfaces 145, which can reside on corresponding devices 144. The shared drive system 100 can operate to implement a shared drive amongst multiple devices 144, with a structure and organization of the shared drive being reflected in a drive schema 155. In examples, the devices 144 may each have a view or perception of the shared drive, which can be in the form of a corresponding local instance 105. In particular, each device can include a local instance 105 of the shared drive, which includes locally stored items, as well as a local copy or version of the drive schema 155. In some implementations, the devices 144 can correspond to end user computing devices, such as laptop/desktop computers, tablets, mobile computing devices, or wearable computing devices. Accordingly, the devices 144 can operated under different platforms (e.g., operating systems), and each device 144 can include a shared drive interface 145 in order provide the shared drive 105.

The shared drive interface 145 can be implemented as a service application which communicates with the network service 102 using, for example, an Internet (and/or other network) connection. The network service 102 can be implemented on a server, or set of servers. In variations, the service 102 can be implemented using end user computers, such as on one or more computers that implement the shared drive 105.

In an example, the drive schema 155 of shared drive system 100 includes a drive manager 110, a file services 120, a restoration service 130, and a device interface 140. In some variations, the device interface 140 can be implemented as an agent or instance that is suited for a particular platform, connection or device. The shared drive system 100 can use the schema 155 to define a local instance 105 of a shared drive on multiple devices. The devices 144 of a given shared drive can be designated by the user or operator via settings 143. In one implementation, the user can establish an account with a network service on which the shared drive system 100 is provided. With the established account, the user can download applications (which provide drive interface 145) for each of the designated devices 144, resulting in each device including a local instance 105 of the shared drive. The local instance 105 can include local files of the particular device, and at least a portion of the schema 155 for defining the location and other contextual information about the local files which are part of the shared drive. Once implemented, the local instance 105 of the shared drive can provide a collection of documents and media files on each of the designated devices 144.

The drive manager 110 can implement and maintain a drive schema 155 for the local instance 105 of the devices 144. In one implementation, the drive interface 145 of each device 144 performs a scan to identify the local files and resources which can be provided as part of the local instance 105 of the shared drive. In a setup mode, the drive interface 145 of each device 144 communicates device information 149 to the shared drive system 100 via the device interface 140. The drive manager 110 can use the device information 149 from each designated device 144 to generate schema input 103 for the drive schema 155. The drive manager 110 can aggregate and organize device information 149 into drive schema 155. In this way, the drive schema 155 can provide a data representation of the shared drive, including a representation of the locally stored items which each device 144 stores or otherwise provides for the shared drive. In one implementation, the items of the shared drive can include designated devices 144, folders which are selected by the user or operator for the shared drive, specific files and/or other network entities or resources.

The drive schema 155 can associate individual items 113 with corresponding components of the 105. The drive schema 155 can also include data which identifies the organizational structure of the shared drive, including the relative organization of each item 113 with respect to another item. For example, the drive schema 155 can list items 113 which correspond to devices, as well as items (e.g., folders, files) which are organized to branch from other devices. As described with various examples, the drive schema 155 can be communicated to individual devices 144 which maintain the local instance 105 of each drive.

Additionally, once the drive schema 155 is created for a specific shared drive, the shared drive system 100 can update the drive schema 155 based on events which modify and update the organization structure of the shared drive. The events can include, for example, (i) the addition or deletion of devices which the user designates for the shared drive, (ii) the addition or deletion of folders or files of the shared drive, (iii) changes to network entities which are part of the shared drive, (iv) designation of users or accounts on one or more of the devices which are part of the shared, and/or (v) changes to the organization structure of the shared drive, including changes to the name of devices, folders, or network resources, as well as move operations of items which are part of the shared drive.

According to some examples, events which modify the 105 correspond to one or more drive operations 111, such as specified by user input on a given one of the devices 144. The drive operations 111 can be communicated to the drive manager 110 via the device interface 140. The drive manager 110 can process the drive operations 111, and perform a corresponding schema input 103 on the drive schema 155. The schema input 103 can serve to update the drive schema 155 to be current, reflecting the change to the shared drive which results from performance of the drive operations 111.

The drive manager 110 can also initiate one or more file services 120 to implement certain types of drive operations 111. In some variations, the drive operations 111 include (i) a viewer 122 to generate view data 121 for a user generated request to view or render one or more specific files of the shared drive which are not local to the requesting device 144, (ii) a downloader 124 to download data 123, corresponding to one or more specific files residing with one of the other devices or network entities of the share drive onto the requesting device, and/or (iii) an uploader 126 to receive upload data 125 from the device 144, for one or more specific files which the user may want to transfer to a particular network location, such as an online storage resource. The performance of some types of operations of file services 120 can trigger the drive schema 155 to be updated with corresponding schema input 103.

In one implementation, the drive manager 110 includes a schema manager 112, a schema signature determination component 114, and a drive state check 116. The schema manager 112 includes logic to determine the schema input 103 based on the drive operation 111. The schema manager 112 can also record information about the drive operation 111 and/or resulting schema modification (“modification event 129”). The information about the modification event 129 can, for example, identify the drive operation 111 which modifies the drive schema 155. By wav of example, the information about the modification even 129 can identify drive operations 111 such as adding/deleting a given device or folder for the shared drive, changing the name of a device or folder which is provided on the shared drive, and/or moving or changing the organization of devices, folders, network entities, or files so that the organization structure of the shared drive is changed.

The schema signature determination 114 can include logic to determine a schema signature 133 of the drive schema 155. The schema signature determination 114 can determine the schema signature 133 from the drive schema 155, after each instance when the drive schema 155 is updated. In one implementation, the drive manager 110 communicates the schema input 103 to update the drive schema 155, so that a modification or change resulting from the drive operation 111 is reflected in the schema signature 133. The schema signature determination component 114 can store the schema signature 133 in a signature store 135. The signature store 135 can store a list of signatures 133, reflecting the drive schema 155 in prior states, coinciding with prior versions of the shared drive. The schema signature 133 can also be paired with information 129 about the modification event, so that each determination of the schema signature 133 is stored in a schema event store 125, in association with information 129 about the corresponding modification which caused the schema update. As described below, the schema signature 133 can be a quantified representation of the shared drive, as represented by drive schema 155. The schema signature 133 can be based on various attributes or characteristics of drive schema 155, such as the number of devices, folders and entities which are included in the shared drive, the names of the devices and folders, the number of files associated with each device or folder, and information about specific items or aggregation of items. The information about specific items or aggregation of items can include, for example, the number of files, file types its use, number of files of specific type, date of creation of folders and/or files of specific characteristics, and the date when a specific device was added the shared drive.

In some implementations, each device may include a local set of files which are provided an organization that is dictated by the drive schema 155. In some examples, the devices 144 each retain a local set of files, which are made available for viewing or access to other devices 144 of the shared drive through the network service 145. Thus, the files which are local to each 144 may not have counterparts (e.g., copies) on other devices 144 of the shared drive system 100. In such implementations, examples recognize that each device uses local schema data 165 to structure the local files for the shared drive 105. The local schema data 165 can include, for example, (i) data which identifies a selection of devices and resources which are part of the shared drive, (ii) names of devices, folders, or files, (iii) account names which are part of the share drive, and (iv) organizational data which identifies the organization amongst users, devices, network entities, and files. Optionally, the local schema data 165 can at least partially reside in a separate data structure on corresponding devices 144 which are part of the shared drive.

Examples recognize situations in which a particular device 144 includes a local instance 105 of the shared drive which is out of date. In such cases, the local schema data 165 will not match the drive schema 155. Examples further recognize that updating the device can result in data loss and/or a more intensive and less efficient restore operation, unless the difference between, the local schema data 165 and the drive schema 155 is accounted for in a manner that avoids data loss. For example, the organizational structure of the shared drive can change when the user (i) adds or deletes a device from the shared drive, (ii) creates, modifies or deletes a folder of the shared drive, and/or (iii) changes a folder or device name. If the update to the particular device is performed by simply replacing the local schema data 165 with the drive schema 155 (which is current), or by overwriting the local instance 105 of the shared drive with contents dictated by drive schema 155, then affected local files can be lost or without contextual information.

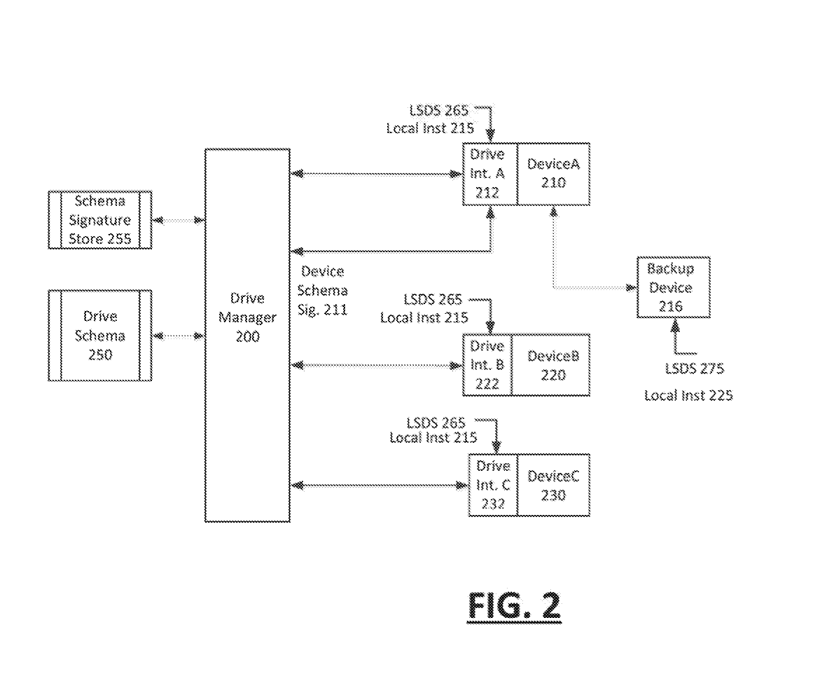

In this regard, an example of FIG. 1 recognizes situations and use cases when devices which are used with shared drive system 100 may have an outdated representation of the shared drive and the drive schema 155. In such cases, an example of FIG. 1 updates the particular device in a manner that allows for the local files and folders to be properly mapped to locations dictated by a current version of drive schema 155. By way of example, the user can backup one of the devices 144 onto a backup device (see FIG. 2), but the backup operation may be performed intermittingly. Thus, hours, days, or even weeks may pass between the time the backup is made and when it is used. At the time of the first backup, the device 144 being backed up can copy local files, with current schema data from the drive schema 155, onto the backup device. This serves to create a backup version of the shared drive. Thus, as with other devices 144 which are part of shared drive system 100, the backup device may include a local set of files which have no counterpart on the other devices 144 that are provided for the shared drive. Furthermore, the local files of the backup drive may be organized in accordance with local schema data 165 which does not match the current drive schema 155. Additionally, in some variations, the backup device may include a representation of the shared drive, so that local schema data 165 selects information about shared drive as a whole (as represented by the drive schema). Examples recognize, however, that the local instance of the backup device will become out of date when the drive schema 155 is updated.

Under conventional approaches, when the backup device is used to restore or establish shared drive on one of the devices 144, the lack of organizational data for the local files results in the restored/new device incurring data or organizational loss, and/or carrying a mismatched version of the drive schema 155. In contrast, an example of FIG. 1 identifies a set of mapping operations 131 to implement on the restored/new device so that the local version of the shared drive is consistent with the drive schema 155.

According to some examples, a given device can communicate a local drive signature 107, based on its local version of the shared drive, to the drive manager 110 via the device interface 140. The local drive signature 107 can be communicated automatically (e.g., each time a device contacts the service drive interface 145) or in response to certain events, such as a manual input or a backup or restore operation. The drive interface 145 can determine the signature based on a predetermined process that is shared (or substantially shared) with schema signature determination 114. As described previously, the predetermined process can take into account various characteristics and attributes of the local instance 105 of the shared drive, which is reflected by the corresponding version of the drive schema. Such characteristics and attributes include number of files, file types in use, number of files of specific type, date of creation of folders and/or files of specific characteristics, date when a specific device was added to the share drive, and/or other characteristics and attributes.

The drive state check 116 can include logic to receive the local drive signature 107, and to compare the local drive signature 107 to stored signatures of drive schema 155 (which are shown as being maintained in the signature store 135). The drive state check 116 can perform a comparison operation in order to determine a matching schema 137 from the local drive signature 107. The matching schema 137 can correspond to the drive schema 153 when in a prior state. The drive state check 116 can then reference the matching schema 137 to a list or repository of events (as shown by schema event store 125) to identify a subset of events (“schema modification set 135”) which have changed or modified the drive schema 155 from the time since when the schema was in the prior state reflected by the matching schema 137.

The drive manager 110 can initiate the restoration service 130 in which a mapping component 132 identifies the set of mapping operations 139 for the connected device 144 based on the schema modification set 135. The mapping operations 139 may be specifically selected for the device 144 based on, for example, a platform of the particular device, resources or capabilities of the device, and/or permissions or account settings of the device in the latter case, the account or permission settings may preclude, for example, the particular device 144 from receiving data for a portion of the shared drive, as defined by the drive schema 155.

The restoration service 130 can communicate the mapping operations 139 to the connected device 144 through the device interface 140. The connected 144 can in turn implement the mapping operations 139 in a manner that structures and organizes the local files in accordance with the current drive schema 155. Additionally, portions of the local instance, as reflected by the current drive schema 155, can be provided on the connected device 144 so that the device is current with respect to the drive schema 155.

FIG. 2 illustrates an example system in which a backup device can be provided a local instance of a shared drive. In an example of FIG. 2, a set of devices 210, 220, 230 can correspond to, for example, a set of user selected devices for establishing the share drive. Each device 210, 220, 230 includes a corresponding drive interfaces 212, 214, 216, respectively. the drive interfaces 212, 214, 216 can be implemented as applications which are installed on the respective device 210, 220, 230. In some examples, the devices 210, 220, 230 share different platforms or operating systems, and the respective interfaces 212, 214, 216 can correspond to applications which run in the platform of the corresponding device.

Each interface 212, 214, 216 can execute processes which link the respective device 210, 220, 230 to a server (or set of servers) on which a drive manager 200 is provided as a service. In an example of FIG. 2, the drive manager 200 can be implemented as part of the network service drive 102 for shared drive system 100. The drive manager 200 can operate to establish the shared drive amongst the devices 210, 220, 230. In some examples, the shared drive includes a virtual representation of a drive (e.g., directory), where items such as files and folders are maintained locally on one of the corresponding devices 210, 220, 230. In providing the virtual representation, the drive manager 200 can maintain a drive schema 250, similar to the drive schema 155 of shared drive system 100, as described with examples of FIG. 1.

In some implementations, each device 210, 220, 230 maintains a respective local instance 215 of the shared drive, which may be defined at least in part by a corresponding local schema data set 265. Each device 210, 220, 230 can arrange a respective local portion of the files, folders and other items of the drive in accordance with the local schema data set 265. In an example of FIG. 2, the drive manager 200 provides each device 210, 220, 230 with the corresponding local schema data set 265 after each instance when the drive schema 250 is updated. In turn, each device 210, 220, 230 updates the corresponding local instance 215 using the local data set 265. As a result, the devices 210, 220, 230 are able to maintain the respective local instance 215 of the local drive current, to match the schema 250 maintained by the drive manager 200.

Each time the shared drive is updated, the drive manager 200 can also record a signature (e.g., thumbprint) of the drive schema. The drive manager 200 can maintain a list of signatures for each prior version of a drive, for a particular time period. With the list, the drive manager 200 can also record the event or events which changes the shared drive (e.g., user file or drive operations, such as device or file name changes, additions/deletions of devices or folders, addition or deletions of files in folders, change in users or accounts, etc.). In an example shown, a drive signature store 255 is shown which represents the data which the drive manager 200 maintains to link prior versions of schemas with signatures and events which changed the schemas.

In an example of FIG. 2, one of the multiple devices 210, 220, 230 is backed up at a given instance in time. For example, the backup operation can include copying local files and folders from the device 210 to a backup device 216. Along with the local files and folders, the backup operation can include copying the local instance 215 of the shared drive, including backup schema data set 275 which identifies the items of a backup instance 255 of the shared drive, as well as the organization of the items as provided within the device 210. For items of the backup instance 225 which are local, the backup schema set 275 can identify the location and organization of the item within the memory of the device 210. In many cases, the backup device 216 is not connected and thus not updated when the schema 250 is updated.

By way of example, the backup device 216 can correspond to a thumb drive, memory disc, or alternative computer or device which is used as a memory resource. In variations, an online backup resource can be used in place of the backup device 216. An example of FIG. 2 recognizes that backup operations are typically discrete events, and in context of providing the shared drive, the backup device 216 may not be connected or capable of being in communication with the device 210 or the drive manager 200 for purpose of receiving the local schema data set 265 once the backup operation is performed. However, the shared drive can be in active use by the devices 210, 220, 230, meaning the drive manager 200 may update the drive schema 250 repeatedly. Over time, the schema 250 is updated, while the backup drive 216 and the local instance are not. Consequently, the schema representation of the backup instance 225 will not match the current form of the drive schema 250. Additionally, local file which are part of the backup instance 225 can lose their context (e.g., organization).

The backup device 216 can be used to perform, for example, a restore operation on the device 210. Alternatively, the backup device 210 can be used to replace the device 210 with a new device. In order to restore from the backup device 216 in a manner that maintains the structure and organization of the current schema 250, particularly with reference to local files, the drive manager 200 can provide a mapping service or function. In one implementation, the drive manager 200 can communicate with either the backup device 216 directly, or with the device 210 (or other device) on which the local instance is copied. The drive manager 200 obtain schema signature data 221 for the backup schema 275, and the drive manager 200 can identify or otherwise determine the signature of the schema 250 when in a prior version. A signature store 255 can maintain a signature 221 of the schema 250 when the schema is updated. The signature 221 can be referenced against the signatures of the schema for prior versions of the shared drive, so as to identify a matching prior version of the schema 223 from the drive signature store 255.

From the identified prior version, a set of modifications 229 which have since been performed on the shared drive can be identified. In one implementation, the drive manager 200 specifies a set of mapping operations 227 for the local instance 215 of the shared drive. The specified set of operations 227 can replicate or otherwise re-create the effect of the set of modifications 229 which were identified as having been performed on the shared drive. For example, the set of operations 227 can implement each of the identified set of modification 229 on the local instance of the shared drive. Moreover, when relevant, the drive manager 200 can specify the set of operations 227 in a manner that provides for some or all of the modifications to be implemented on the local instance 215 of the shared drive in the sequence which those modifications were performed on the prior versions of the shared drive. In this way, the local instance 215 of the shared drive can be made current, such that the schema of the local instance substantially matches or otherwise conforms to the schema 250 of the current shared drive.

Methodology

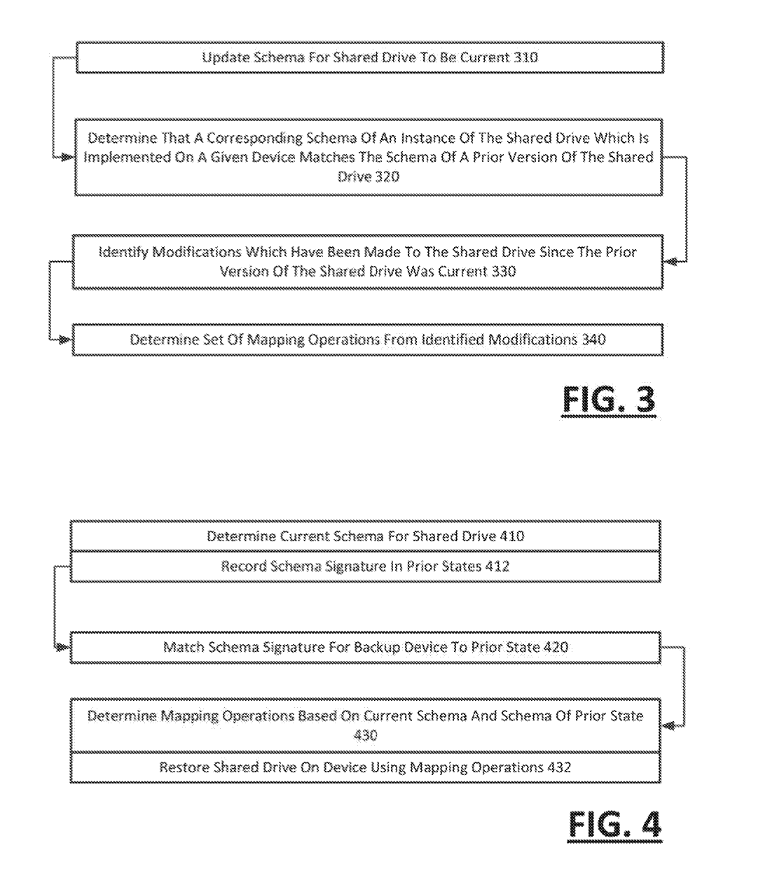

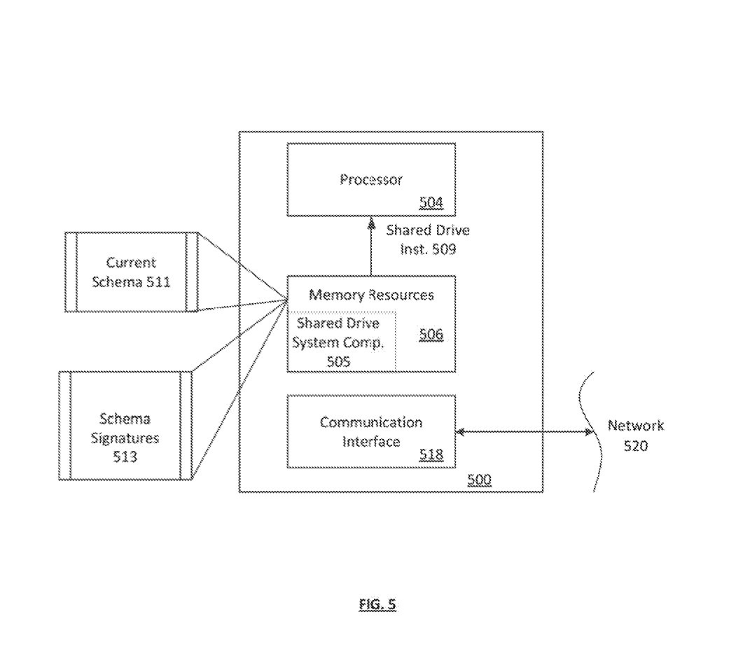

FIG. 3 illustrates an example method for updating instance of a shared drive that is out of date. FIG. 4 illustrates an example method for updating an instance of a shared drive which is to be used in order to back up or establish a new device for use with a shared drive. In describing examples of FIG. 3 and FIG. 4, reference may be made examples of FIG. 1 or FIG. 2 for purpose of illustrating suitable components or elements for performing a step or sub-step being described.

With reference to an example of FIG. 3, a network computer or service can operate to update a schema of the shared drive that is in use by multiple devices (310). For example, a shared drive may be distributed amongst two or more connected devices of the user, and the user may provide input that alters the shared drive in some way. for example, the user may add/remove devices and/or network entities or resources (e.g., online accounts) which are connected or otherwise available to the shared drive, add/remove user accounts on individual devices or resources which can be used, change device and/or folder names, and/or move items (e.g., files) relative to other items (e.g., folders or directories). When the schema 155 of the shared drive changes, the drive manager 110, for example, can obtain the current signature 133 of the current schema 155. Additionally, the modification to the shared drive that results from the user input can be identified and linked to the prior and/or current version of the stored drive.

The drive manager 110 can encounter an outdated instance of the shared drive from a variety of sources, such as from backup devices, or from devices which obtain files and other data from a backup device or resource (e.g., online account). The schema of the local instance 105 of the shared drive can be determined and matched to a recorded schema of a prior version of the shared drive, as managed from the network service or computer for the multiple devices (320). In order to match the schema of the local instance 105 to that of a prior version of the shared drive, the signature of the schema for the local instance 105 to that of a prior version of the shared drive, the signature of the schema for the local instance can be compared to the signature of the schemas 133 for multiple prior versions of the shared drive. The signature comparison can identify a specific prior version or state of the shared drive which likely was the source from which the local instance 105 was made or last updated. As mentioned with other examples, the 107 signature can be determined or extracted from the schema data 165 of the local instance 105. The signature 107 can correspond to any data element which identifies a state or version of the shared drive from other states or versions of the same drive over a given time period. In some implementations, the signatures are unique to the particular state version or state of the shared drive, as compared to other versions or states of the same shared drive.

The network service 102 which manages the shared drive can record events which modify the shared drive over time. When the matching schema to the prior version of the shared drive is determined, a set of modifications which occurred to update the shared drive and the drive schema 155, from the time when that particular prior version was current, can be identified (330). In some variations, a sequence in which the modifications can also be determined.

The modifications can be implemented as a set of mapping operations on a device which utilizes the outdated instance of the shared drive (340). The set of operations can thus conform to the platform of the device which is going to bring the instance of the shared drive up to date. As described with other examples, the set of mapping operations can map files or other items which may be local to the device on which the local instance of the shared drive is provided, to a drive space on the same device which is associated with the structure and organization of the current schema. In this way, the local instance of the shared drive can be brought up to date, while the mapping operations ensure that the contextual aspects of the local items which are provided with the shared drive match those of the current version of the shared drive, in conformance with the drive schema.

With reference to FIG. 4, the current schema 155 for the shared drive can be determined (410), as described with an example of FIG. 3. Likewise, a signature 133 can be identified for the current schema 155 of the shared drive after each instance where it is updated (412). Additionally, the event or operation which caused the modification to the schema 155 can be recorded and associated with the current schema's signature 133 (414).

When the local instance 105 of the shared drive is obtained or otherwise utilized from the backup device 216, the network service can match the signature 107 of the schema for that local instance 105 with the signature 133 of the schema 155 of one of the prior versions of the shared drive (420). Based on signatures, the matching schema of the prior version of the shared drive can be identified which is comparable or equivalent the schema of the local instance 105.

When the matching schema of the prior version of the shared drive is identified, the modifications which occurred on the shared drive since the point in time when the prior version was current are identified. The modifications can be implemented as a set of mapping operations 139 when a device restores data that includes the local instance 105 of the shared drive from the backup device 216 (430). The mapping operations 139 facilitate local files which may be resident on the device receiving the backup to have appropriate context which is in conformance with the current schema 155 of the shared drive (432).

FIG. 5 is a block diagram that illustrates an example computer system upon which embodiments described herein may be implemented. For example, in the context of FIG. 1, security device 110 may be implemented using one or more servers such as described by FIG. 5. In describing FIG. 5, reference may be made to elements of FIG. 1 for purpose of illustration and examples.

In an embodiment, computer system 500 includes processor 504, memory resources 506 (including non-transitory memory), and communication interface 518. Computer system 500 includes at least one processor 504 for processing information. Computer system 500 also includes the main memory 506, such as a random access memory (RAM) or other dynamic storage device, for storing information and instructions to be executed by processor 504. For example, main memory 506 can store logic 505 for implementing a shared drive system such as described with an example of FIG. 1. The memory resources 506 also may be used for storing temporary variables or other intermediate information during execution of instructions to be executed by processor 504. Computer system 500 may also include a read only memory (ROM) or other static storage device for storing static information and instructions for processor 504. The memory resources 506 can also include storage devices, such as a magnetic dish or optical disk, is provided for storing information and instructions. The communication interface 518 may enable the computer system 500 to communicate with one or more networks through use of the network link 520 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Embodiments described herein are related to the use of computer system 500 for implementing the techniques described herein. According to one embodiment, those techniques are performed by computer system 500 in response to processor 504 executing one or more sequences of one or more instructions contained in main memory 506. Such instructions may be read into main memory 506 from another machine-readable medium, such as a storage device. In some examples, the memory 506 can store a shared drive system component 505, corresponding to a program or set of programs which combine to provide, for example, the network service 102 of the shared drive system 100 (see FIG. 1).

Execution of the sequences of instructions contained in main memory 506 causes processor 504 to perform the process steps described herein. For example, processor 504 can execute instructions 509 for implementing the network service 102 of the shared drive system, as shown with an example of FIG. 1. The shared drive logic instructions 509 can thus serve to maintain a drive schema 511, as well as determine signatures of the schema for a schema signature store 513 when modifications are made. The processor 504 can further execute instructions which record events or operations which modified the schema 511 along with the modifications which caused the change. Further, the processor 504 can use the instructions 509 to identify mapping operations or actions which a device with an out of date instance of the shared drive can use in order to restore and be in conformance with the current schema.

In variations, the processor 504 can be an end terminal which maintains, for example, a “master copy” of the schema 511 for the shared drive, and further records signatures and modifications to the schema of the shared drive 155. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

1. A method for using a shared drive, the method being implemented by one or more processors and comprising:
(a) updating a schema for the shared drive to be current, the schema including (i) a collection of items and (ii) an organization for the collection of items, the organization specifying a location of individual items relative to other items in the collection;
wherein the collection of items includes multiple sets of items of different kinds, including items representing each of (i) multiple devices that are operable to contribute files to the shared drive, and (ii) multiple folders that are provided for the shared drive;
(b) determining that a corresponding schema of an instance of the shared drive which is implemented on a given device matches the schema of a prior version of the shared drive;
(c) identifying one or more modifications which have been made to the shared drive since the prior version of the shared drive was current;
(d) determining, from the one or more modifications, a set of mapping operations for updating the instance of the shared drive on the given device so that the corresponding schema matches or conforms to the schema that is current.

2. The method of claim 1, further comprising determining a signature of the corresponding schema of the instance of shared drive, and wherein (b) includes comparing the signature of the corresponding schema with the signature of one or more schemas of prior versions of the shared drive.

3. The method of claim 1, wherein determining the signature is based at least in part on information associated with each device of the multiple devices and each folder of the multiple folders.

4. The method of claim 3, wherein the signature is based on a name or property of each device of the multiple devices or each folder of the multiple folders.

5. The method of claim 1, further comprising using the set of mapping operations to map a set of files which are either local on the given device or being imported from another device, to locations in memory on the given device which are for use with the shared drive.

6. The method of claim 1, further comprising using the set of mapping operations to restore or establish the shared drive on the given device.

7. The method of claim 1, wherein (b) includes determining which of a plurality of schemas which correspond to a plurality of prior versions of the shared drive match the schema of the instance of the shared drive on the given device.

8. The method of claim 1, further comprising:
recording information about each of a plurality of events that change the schema over a duration which precedes the schema being current, the information identifying each instance when a corresponding user of one of the multiple devices changes the schema; and wherein (c) includes identifying a subset of the plurality of events which occur since when the matching schema of the prior version was current.

9. A computer system comprising:
a set of memory resources to store a set of instructions;
one or more processors that execute the instructions to:
provide a shared drive for a plurality of devices;
determine a schema for the shared drive at multiple instances over a given duration, the schema including (i) a collection of items and (ii) an organization for the collection of items, the organization specifying a location of individual items relative to other items in the collection;
wherein the collection of items includes multiple sets of items of different kind, including items representing each of (i) multiple devices that are operable to contribute files to the shared drive, and (ii) multiple folders that are provided for the shared drive;
determine a signature of the schema after each of multiple times in a given duration when the schema is updated;
match a signature of an instance of the schema on a given resource so the signature of the schema in one of the multiple prior states;
determine a set of mapping operations for mapping items of the schema in the matched prior state to corresponding items of the schema that is current, and
implement the mapping operations in connection with restoring the instance of the share drive so that the schema of the instance matches or conforms to the schema of the shared drive that is current.

10. The computer system of claim 9, wherein the one or more processors restore the instance of the shared drive on the given resource.

11. The computer system of claim 9, wherein the one or more processors restore the instance of the shared drive on a second device that utilizes the given resource as a backup resource.

12. The computer system of claim 9, wherein the one or more processors determine the signature of the schema after each of the multiple instances using information associated with each device of the multiple devices and each folder of the multiple folders.

13. The computer system of claim 12, wherein the signature is based on a name or property of each device of the multiple devices or each folder of the multiple folders.

14. The computer system of claim 9, wherein the computer system is implemented as part of a network service.

15. A non-transitory computer-readable medium that stores a set of instructions, which when executed by one or more processors of a computer system, cause the computer system to perform operations comprising:
(a) updating a schema for the shared drive to be current at multiple instances over a given duration, the schema including (i) a collection of items and (ii) an organization for the collection of items, the organization specifying a location of individual items relative to other items in the collection;
wherein the collection of items includes multiple sets of items of different kinds, including items representing each of (i) multiple devices that are operable to contribute files to the shared drive, and (ii) multiple folders that are provided for the shared drive;
(b) determining that a corresponding schema of an instance of the shared drive which is implemented on a given device matches the schema of a prior version of the shared drive;
(c) identifying one or more modifications which have been made to the shared drive since the prior version of the shared drive was current;
(d) determining, from the one or more modifications, a set of mapping operations for updating the instance of the shared drive on the given device so that the corresponding schema matches or conforms to the schema that is current.
